(19) United States
(12) Patent Application Publication
(10) Pub. No.: US 2008/0118702 A1
(43) Pub. Date: May 22, 2008

(54) Process for Producing a Honeycomb Body with a Metallic Fleece, Honeycomb Body Produced by the Process and Process for Filtering an Exhaust-Gas Stream

(75) Inventor: Rolf Bruck, Bergisch Gladbach (DE)

Correspondence Address: LERNER GREENBERG STEMER LLP, P O BOX 2480, HOLLYWOOD, FL, 33022-2480, US

(73) Assignee: EMITEC GESELLSCHAFT FUR EMISSIONSTECHNOLOGIE MBH, Lohmar (DE)

(21) Appl. No.: 11/957,697

(22) Filed: Dec. 17, 2007

Related U.S. Application Data
(63) Continuation of application No. PCT/EP2006/005534, filed on Jun. 9, 2006.

(30) Foreign Application Priority Data
Jun. 17, 2005 (DE) DE102005028031.5

(51) Int. Cl. B32B 3/12

(52) U.S. Cl. 428/116; 428/593

(57) ABSTRACT

A process for producing a honeycomb body with at least one fleece having metallic fibers, includes at least the following steps:

producing metallic fibers;

forming a layer having metallic fibers;

welding the metallic fibers to one another;

deforming the layer to form a fleece having defined fleece properties;

producing a honeycomb body; and

brazing the honeycomb body. A honeycomb body produced according to the process is suitable in particular for filtering exhaust gases from a motor vehicle. A process for filtering an exhaust-gas stream is also provided.

### CROSS-REFERENCE TO RELATED APPLICATIONS

This is a continuing application, under 35 U.S.C. § 120, of copending international application No. PCT/EP2006/005534, filed Jun. 9, 2006, which designated the United States; this application also claims the priority, under 35 U.S.C. § 119, of German patent application No. DE 10 2005 028 031.5, filed Jun. 17, 2005; the prior applications are herewith incorporated by reference in their entirety.

### BACKGROUND OF THE INVENTION

### Field of the Invention

The present invention relates to a process for producing a honeycomb body with at least one fleece having metallic fibers. The invention also relates to a corresponding honeycomb body and to a process for filtering an exhaust-gas stream.

Such honeycomb bodies may perform various functions in exhaust systems of internal combustion engines. By way of example, they are used as catalyst carrier bodies, as what are known as adsorbers, as filters, as flow mixers and/or as mufflers. The honeycomb body is usually distinguished by a favorable ratio of surface area to volume, i.e. it has a relatively large surface area and therefore ensures intensive contact with a gas stream flowing along or through it. Honeycomb bodies of that type are usually constructed with a plurality of different components (metal sheets, mats, tubes, etc.), in some cases including different materials (steel materials, ceramic substances, mixed materials, etc.). Those individual components have to be permanently connected to one another in view of the high thermal and dynamic stresses in exhaust systems of mobile internal combustion engines. Various connection techniques are known for that purpose, for example brazing and/or welding.

With regard to the connection techniques, it is necessary to bear in mind that they need to be suitable for medium-sized series production. In that context, cost aspects also play an important role, for example cycle rates, connection quality, process reliability, etc. Known processes for forming connections by joining techniques require an additional material, such as for example brazing material or welding filler. In that context it is particularly important for the additional material to be applied accurately at the location at which a connection is subsequently to be generated. Moreover, it should be noted that increasingly thin-walled materials are to be used, since they can very quickly adapt to the temperature of the exhaust gas and accordingly react in a very dynamic way.

Ceramic and metallic filter materials have already been tested, particularly when producing honeycomb bodies for filtering an exhaust-gas stream and/or for at least temporarily retaining solids contained in the exhaust gas, such as particulates, ash, soot and the like. As explained above, in view of the fluctuating thermal stresses acting on a honeycomb body of that type, it should be ensured that the thermal expansion properties of the components of the honeycomb body do not differ excessively from one another. That fact, together with improved processibility, have in very recent times led to increased use of metallic filter materials. Those are formed with a gas-permeable, in particular porous fiber layer. In that context, the term fiber is to be considered a generic term encompassing in particular also wires, chips and the like. The production of metal filter media of that type and their integration into the production processes for a honeycomb body accordingly constitutes a particular manufacturing technology requirement. The metallic filter materials need to be adapted to the intended uses of the honeycomb body which is thereby formed, requiring a high degree of flexibility in terms of the manufacturing steps.

### SUMMARY OF THE INVENTION

It is accordingly an object of the invention to provide a process for producing a honeycomb body with a metallic fleece, a honeycomb body produced by the process and a process for filtering an exhaust-gas stream, which overcome the hereinafore-mentioned disadvantages of the heretofore-known processes and products of this general type and which at least partially alleviate the technical problems which have been outlined in connection with the current state of the art. In particular, it is necessary to specify a process for producing a honeycomb body which can be carried out reliably even as part of series production. Moreover, it is intended to improve the ability to recycle honeycomb bodies of this type by using metallic fibers and reusing them. The honeycomb bodies produced by the process, within series production, should have only minor deviations in terms of functionality and service life. It is also intended to specify specially configured honeycomb bodies and preferred application areas for these honeycomb bodies.

With the foregoing and other objects in view there is provided, in accordance with the invention, a process for producing a honeycomb body with at least one fleece having metallic fibers. The process comprises the following steps:
a) producing metallic fibers;
b) forming a layer including the metallic fibers;
c) welding the metallic fibers to one another;
d) deforming the layer to form a fleece having defined fleece properties;
e) producing a honeycomb body including the fleece; and
f) brazing the honeycomb body.

The individual steps and details of their configuration are explained in more detail below, including reference to the particularly preferred configurations.

The word “fiber” serves in particular to describe an elongate element and especially also encompasses elements in wire form, in chip form and the like. The metallic fibers may be substantially round, oval or polygonal in form. Fibers with a flat cross section are particularly preferred. The metallic fibers include in particular a material which substantially includes steel as a base material, with high chromium (e.g. in a range of from 18 to 21% by weight) and/or aluminum contents (e.g. at least 4.5% by weight, in particular at least 5.5% by weight), preferably being provided. The metallic fibers are preferably constructed with a fiber length in a range of from 0.1 to 50 mm (in particular in a range of from 1 to 10 mm) and a fiber diameter in a range of from 0.01 to 0.1 mm (in particular in a range of from 0.02 to 0.05 mm).

In this context, it should in principle be mentioned at this point that with regard to configuring the process for series operation, the process steps should take place as continuously as possible, in which context steps b), c) and/or d) should preferably be carried out at a rate of advance of at least 3 meters per minute (m/min), preferably at least 5 m/min or even 10 m/min.

With regard to step e), under certain circumstances separate assembly operations may be necessary, requiring discontinuous operation, but these should nonetheless be carried out at correspondingly high cycle rates. Step f) ensures that the individual components of the honeycomb body are disposed captively with respect to one another, so that the honeycomb body is able to withstand the high thermal and dynamic stresses in the exhaust system of mobile internal combustion engines.

In accordance with another mode of the invention, with regard to the production of metallic fibers, it is particularly advantageous for step a) to include at least one of the following production methods:
a.1) separating from a metal block;
a.2) continuous fiber production from a metal melt; and
a.3) discontinuous removal from a metal melt.

The “separation” from a metal block in accordance with method step a.1) includes in particular also milling, drilling, turning, planing, rasping, cutting or similar, in particular chip-producing, manufacturing processes. The chip in this case constitutes the fiber. Whereas a broken chip is formed at regular intervals during milling, planing and rasping, turning or drilling can also produce very long chips. A metal block is to be understood in particular as meaning a solid body made from metal. The specific configuration of the body is to be selected on the basis of the production process used for producing the chips or fibers. Accordingly, the metal block may be in the form of a cylinder, a cuboid, a wire or in similar form.

In the case of continuous fiber production (see method step a.2)), a wire-like, very long or so-called “endless” fiber is produced from the metal melt. In this case, the fibers can be drawn or extruded individually or as a combined set. The person skilled in the art can refer, for example, to corresponding descriptions on the production of wires for clarification of this production method.

The discontinuous removal of the fibers from a metal melt (see method step a.3)) represents, as it were, a mixed method somewhere between method steps a.1) and a.2). By way of example, a rotor with a structured circumferential surface is moved relative to the metal melt, with parts of the metal melt being removed from the bath as a result of temporary contact and these parts of the metal melt subsequently cooling to form the metallic fibers. In this case, fibers are produced repeatedly and discontinuously at a high speed.

In accordance with a further mode of the invention, it is particularly advantageous if, during step a), at least from time to time measures are taken to avoid an oxide layer on the fibers. This applies in particular to production method step a.1), since in this case very high temperatures may under certain circumstances occur during production of the fibers. An oxide layer on the surface of the fibers can impede subsequent processing steps and/or endanger their reliable execution. Therefore, it is proposed at this point, by way of example, that a cooled atmosphere and/or an atmosphere with a reducing action be provided continuously and/or intermittently. By way of example, coolant and/or a shielding gas including argon and/or helium can be supplied during separation of the fibers from a metal block. Both measures, as well as other known measures, serve to avoid the formation of an oxide layer. In addition, the fibers can also be remachined, so that an oxide layer located on the surface of the fiber is mechanically or abrasively removed. The term “avoid” is also understood to encompass reduced formation (reduction) of oxide layers compared to normal conditions.

In accordance with an added mode of the invention, between step a) and step b) at least a step ab) of fiber preparation is also carried out. This step includes at least one of the following operations:
ab.1) classifying the fibers;
ab.2) selecting the fibers;
ab.3) returning the fibers for reuse;
ab.4) cutting the fibers;
ab.5) mixing the fibers; and
ab.6) cleaning the fibers.

Fiber preparation constitutes an important working step with a view toward the production of honeycomb bodies with targeted, different properties in a production line. In this case, the fibers produced continuously or discontinuously can be inspected for their intended use and predestined accordingly. In the context of fiber preparation, it is intended in particular to compensate for inhomogeneities in the fiber form caused by the process used to produce the fibers.

The “classifying” of the fibers includes in particular recognizing and allocating the fibers to predetermined classes which depend, for example, on the weight, lay, thickness, shape or another parameter of the fibers. In this case, in particular with a view toward production method steps a.1) and a.3), in which the chip shape may vary under certain circumstances, it is proposed that three different classes be provided, into which the fibers being produced are classified. Furthermore, it is also possible to define exclusion criteria, in which case the fibers which meet the exclusion criteria are to be assigned to a further class. It is also possible for sensors to be used for the classification itself, in which case, by way of example, the chip shape, length and the like is recorded through the use of at least one optical sensor. Furthermore, fans, fluids, sieves, etc. can also be used to recognize or classify the fibers.

During the selection of the fibers, the (preferably previously classified) fibers are separated from one another. Fans, fluids, sieves, etc. can also be used for this purpose. If the fibers have been classified into three classes, the fibers from two classes, for example, can be fed for further processing, whereas the fibers in the third class are fed back to the production method as raw material (scrap). After the selecting of the fibers, the fibers which have been separated from one another are separately treated further at least for one subsequent step of the production process.

As has already been indicated above, the classifying or selecting of the fibers in a simple way also allows returning of the fibers for reuse. This is advantageous with a view toward exploitation of raw materials and the environment. The returned fibers can, for example, be melted down again and fed back to the production methods listed above in the form of a metal melt or metal block. In this case, cleaning treatments and/or heat treatments may be provided in between.

The “endless” fibers in particular from the fiber production method corresponding to step a.2) can now be cut to a predetermined length. The cutting of the fibers can be carried out in such a way as to produce a constant and/or varying fiber length. In particular, in the case of a varying fiber length, this process step can also be followed by classifying and/or selecting.

Furthermore, the fibers may also be mixed. This allows, for example, a defined spatial orientation of the fibers to be generated with respect to one another. However, it is also possible for the fibers which are being produced to be mixed with further fibers (for example of a different material and/or a different form). It is also possible to produce a layered configuration of the fibers of different configuration as early as at this stage. However, a random layer of the fibers is ultimately preferred.

Finally, it may also be advantageous for the fibers being produced to be cleaned. This also allows the removal of impurities (soot, oil, etc.), for example including an oxide layer. Cleaning with a fluid is particularly advantageous, in which case differently shaped fibers are also classified and/or selected, if appropriate directly, as a result of different immersion properties.

In accordance with an additional mode of the invention, step b) includes at least one of the following operations:
b.1) distributing fibers on a base;
b.2) adding at least one additive;
b.3) determining at least one layer parameter;
b.4) altering the at least one layer parameter; and
b.5) continuously moving the layer.

It is preferable for a distributor, a vibrator and/or a sieve to be used to distribute the fibers on a base. These appliances are suitable for effecting a large-area or uniform distribution of the fibers on the base. In particular, in the configuration of the production process, including steps ab.1) and/or ab.2), it is also possible to provide a plurality of these appliances, each adding one class of the fibers to the base (in a temporally and/or spatially offset manner). This also allows, for example, the formation of layers of different fibers on the base. Accordingly, the distribution of the fibers, in addition to the layered configuration, can also be configured with a gradient, i.e. with a substantially continuous profile of a fiber property from the underside of the fiber layer to the topside of the fiber layer, or as a random layer, in which the fibers are placed in unordered fashion with respect to one another.

With regard to the addition of an additive, by way of example, it is also possible to add further, metallic filter materials. For example, additives of this type include metallic powders, sintering materials, fabrics, etc. The additive therefore in particular also serves to build up the fiber fleece.

It is advantageous to determine at least one layer parameter during and/or after step b). This provides monitoring of the layer formation, in which the layer is compared, for example, on the basis of a predetermined porosity, a predetermined weight per unit area, a predetermined light reflectivity, a predetermined flow resistance, etc. The layer parameter can be monitored continuously, and when a defined value is reached can lead either to interruption of a process step taking place at the same time or to activation of a further process step.

If appropriate, measures are also provided which allow the determined layer parameter or the layer parameter which is to be determined to be altered. Accordingly, by way of example, it is possible to supply further fibers, additives, etc., the layer can be compacted, and the orientation of the fibers in the layer can be varied. With a view toward the preferred configuration of the process for producing a honeycomb body as a continuous process, it is proposed that while a layer is being formed, the layer be moved continuously. In this case, the base on which the fibers are distributed is advantageously constructed as a conveyor belt. Layer parameters can also be adjusted by varying, for example, the conveying rate. At the same time, a conveyor belt of this type may have measures for determining at least one layer parameter. In order to prevent the layer of fibers from breaking up during the movement, it is also possible for the conveyor belt to be assigned measures which temporarily fix the position of the fibers with respect to one another (such as for example magnetic fields).

In accordance with yet another mode of the invention, step c) includes at least one of the following operations:
c.1) carrying out resistance welding at least once;
c.2) carrying out roller seam welding at least once;
c.3) welding under shielding gas;
c.4) compacting the layer; and
c.5) inspecting the welded joins.

Although in principle other ways of fixing the fibers to one another are known (sintering, mechanical interlocking, etc.), welding is proposed as the preferred joining technique in the present context. Due to the fleece being configured with metallic fibers, resistance welding is suggested, since this can be carried out continuously at a relatively high speed.

Roller seam welding as well as projection welding processes belong to the class of pressure connection welding processes, in particular resistance pressure welding. In resistance welding, the heating at the welding location takes place as a result of Joule resistance heating when current flows through an electrical conductor. The current is supplied through electrodes with a convex or planar working surface. For roller seam welding, two (driven) electrodes in roller form or the like are used. The fibers to be welded in the layer are in this case disposed predominantly overlapping and in contact with one another. The layer including the fibers is then passed through the electrodes, which are at least partially pressed together. Depending on the form of contact, current flows from one electrode through the fibers to the opposite electrode, where weld spots are formed. In order to process the largest possible areas of the layer with a welding installation of this type, it is necessary to ensure that a large number of welded joins are generated as uniformly as possible over the entire region.

In order to accomplish a welded join of this nature, it may under certain circumstances even be necessary for a plurality of welding installations in succession to be used to form the desired welded joins. In this case, the layer is preferably fed continuously firstly through a first welding installation and then a second welding installation. These welding installations are adapted to one another in such a way that new welded connections are generated on the second passage. With regard to steps c.1) and c.2), it should additionally also be noted that these steps can be combined with further processes for forming connections by joining techniques. By way of example, the fibers can be previously woven or then also sintered together.

Due to the high, albeit spatially very restricted, introduction of heat into the metallic layer, there is once again a risk of oxide formation on the fibers, and consequently it is advantageous for the welding of the fibers to one another to be carried out under shielding gas. The shielding gas preferably includes at least one of the components argon and helium.

The layer can be compacted immediately before, during and/or after welding. The compacting of the layer can, for example, take place in such a manner that the layer is passed through two rollers, between which there is a gap, with the gap being smaller than the layer thickness. During the compacting of the layer, it is preferable for the cavities or pores formed therein to be reduced in size, with the fibers also being plastically deformed. In this way it is also possible to achieve a stronger bond between the fibers. If compacting is to take place during the welding process, the welding process is preferably configured as a pressure welding process. Under certain circumstances, the layer can also be compacted again, for example, when it is directly subjected to a second welding process.

It is also possible to inspect the welded connections after the welding operation. In this context, an optical analysis of the moving fiber layer, a targeted deformation of the fiber layer or also a flow resistance of the fiber layer, can be recorded. During bending, for example by deformation about a shaft, the bending forces can be used as a measure of the quality of the welded connection. It is also possible for the welded layer to be exposed to an air stream flowing through it, in which case conclusions as to the welded connections can be drawn from the deformation of the layer, the number of fibers which become detached, etc. In this case, a controlled welding process is preferred, which therefore opens up the possibility of adapting the welding process if inadequate welded connections are established.

In accordance with yet a further mode of the invention, step d) includes at least one of the following operations:
d.1) compacting the layer;
d.2) separating a plurality of fleeces from the layer;
d.3) classifying the fleeces;
d.4) winding, twisting or folding a fleece;
d.5) structuring a fleece;
d.6) stamping out regions of a fleece;
d.7) combining a fleece with closure elements; and
d.8) seaming the layer.

The “compacting” of the layer can be used to set the desired fleece properties (e.g. density, porosity, strength, thickness, etc.). A “fleece” is to be understood in particular as meaning a sheet-like structure which is formed with predetermined “final” dimensions and in which the fibers are disposed randomly or in ordered fashion with respect to one another. Examples of fleeces include woven fabrics, mesh structures, knitted fabrics, random layers, etc. The fleece in this case is preferably formed with fibers which are made from a corrosion-resistant material which is able to withstand high temperatures. This is also intended to apply to all of the other additives of the fleece. The porosity of the fleece being produced is preferably in a range of from 30% to 80%, in particular in a range of from 45% to 60%. The fleece has a preferred weight per unit area in a range of from 250 to 1500 g/m² [grams per square meter].

The separation of a plurality of fleeces (step d.2)) from the layer substantially takes place in a direction which is transverse to the conveying direction of the layer. In this context, it is possible to use stamping tools, blades which move with the layer, i.e. what are known as flying blades, or similar appliances.

In particular, in the case of production with different fleece properties, i.e. a process variant in which only a certain number of fleeces are produced with one fiber fleece property, and then at least one further number is produced with different fiber fleece properties, it is advantageous for the fleeces to be classified accordingly (step d.3)). Then, the different fleeces can also be fed separately to further processing stations. It is also possible to identify scrap parts during the classification and to return these scrap parts for reuse if appropriate.

Whereas heretofore the fleeces were configured as substantially sheet-like structures located substantially in one plane, it is now also possible for the fleeces to be wound and/or twisted and/or stacked and/or folded after operation step d.4). This is to be understood as meaning in particular that the fleece acquires a curvature through plastic deformation. Following this plastic deformation, the fleece can, for example, be bent in an S shape, wound up helically, folded in a star shape, folded in bellows-like fashion, etc. The deformation of the fleece may also take place together with further elements of the honeycomb body (sheet-metal foils, supporting structures, etc.).

In addition to the large-area deformation of the fleece, there is also the possibility of structuring the fleece (step d.5)). During the structuring, a structure no larger than the fleece thickness is introduced into the fleece. Suitable structures are in particular corrugated structures, zigzag structures and/or rectangular structures. These structures subsequently at least partially delimit flow passages of a honeycomb body. In order to produce a structure of this type, it is possible, for example, to use intermeshing corrugated rollers through which the fleece is guided.

According to step d.6), it is also possible to stamp out regions of a fleece. In this case it is possible, for example, to generate openings which, although significantly larger than the pores or cavities in the interior of the fleece, if appropriate also do not exceed a maximum extent of 20 mm. Openings of this type can be used, for example, to set defined partial-flows in the interior of the honeycomb body, to form a bypass or to produce swirling locations in the honeycomb structure. Furthermore, however, it is also possible for a very large region of the fleece to be stamped out, in which case these, for example, disk-shaped fleeces (if appropriate with a diameter of greater than 70 mm, in particular at least 90 mm) can then themselves in turn be used as filter medium, for example in a radial-flow honeycomb body. Of course, a plurality of stamping operations or types of stamping can be carried out simultaneously.

Finally, the fleece can also be combined with closure elements (step d.7)). These are preferably disposed close to an edge of the fleece and for example have a sealing function with respect to the honeycomb body and/or serve for attaching further fleeces and/or housing parts. The closure element being used may, for example, be a cord, a sheet-metal strip, an element including sinter material, a perforated mask, etc.

According to step d.8), seaming of the layer is also proposed. This is to be understood in particular as meaning that the edges of the layer which run in the direction of extent of the layer run substantially parallel, and/or a desired width of the layer is maintained. This can be realized, for example, by removing fibers, with the layer preferably being cut to size.

In accordance with yet an added mode of the invention, step e) includes at least one of the following operations:
e.1) combining at least one fleece with at least one element selected from the group consisting of: at least one metal foil, at least one housing, at least one electrode, at least one honeycomb structure, at least one perforated tube;
e.2) applying glue to at least one fleece or an element connected to it; and
e.3) applying solder or brazing material to at least one fleece or an element connected to it.

The metal foil is preferably a foil with a thickness of less than 0.15 mm, in particular in the range of from 0.03 mm to 0.12 mm. The metal foil includes chromium and aluminum and is based on a steel material which is thermally stable and corrosion-resistant. The metal foil preferably has a corrugated structure. The housing is preferably likewise metallic and in addition to round, oval or polygonal cross sections, may also have any other desired cross section. The housing at least partially accommodates the fleece and/or the metal foil in its interior. The provision of an electrode is recommended in particular if the honeycomb body is to be constructed to be electrically heatable. For this purpose, the honeycomb body may also be assigned insulation layers which partially form a defined flow path through the honeycomb body. When a voltage is applied, the fleece and/or metal foil is heated up in a controllable way due to Joule resistance heating. The heating of the honeycomb body may be advantageous, for example, during the cold-start phase of the exhaust system and/or for the thermal regeneration of a honeycomb body used as a particulate trap. Furthermore, by way of example it is also possible for the honeycomb body together with a further honeycomb structure to be positioned in a single housing. The honeycomb structure can fundamentally be formed by using metal foils or (extruded) ceramic material. If a radial-flow honeycomb body is to be produced, by way of example it is possible for fleeces which have been stamped out in disk shapes to be disposed at defined intervals around at least one perforated tube or within a perforated tube, allowing the gas stream to flow through from regions located on the inner side to regions located on the radially outer side.

At the same time as, or at a different time than, the combining of the at least one fleece with at least one element selected from the group, it is also possible for the fleece and/or an element which is to be connected to it to be at least partially covered with glue. The application of glue (bonding agent, adhesive, etc.) can be carried out through the use of strip material, self-adhesive stickers, a printing process, etc.

Likewise, at the same time as and/or after the combining operation in accordance with step e.1), it is possible for solder or brazing material to be applied to at least part of at least one fleece and/or an element connected to it. The solder or brazing material can likewise be applied in the form of strip material, stickers and/or by a printing process. However, it is also possible for a solder or brazing material in powder form, which sticks to the subregions that have previously been provided with glue, to be fed to the honeycomb body. With regard to the techniques used to apply glue and solder or brazing material to a honeycomb structure, reference is made in particular to the methods which are already known, in particular those owned by Emitec Geschellschaft für Emissionstechnologie mbH, the assignee of the instant application, which can be used in full for further details.

With the objects of the invention in view, there is also provided a honeycomb body. The honeycomb body comprises at least one fleece produced by the process according to the invention. The at least one fleece has at least one fleece property being different over a thickness of the at least one fleece. Passages which are defined at least by the at least one fleece are closed on alternate sides.

In principle, the honeycomb bodies can be produced with a large number of configurations in accordance with the above-described process, for example in the manner of a radial-flow honeycomb body, with passages disposed in a star shape, with passages in the form of a ring or a bellows or as an open particulate trap in which none of the filter passages is completely closed. However, in particular with a view toward a honeycomb body being used in the exhaust system of mobile internal combustion engines (spark-ignition and diesel engines) with a very high purifying action with regard to the particulates contained in the exhaust gas, the invention herein proposes a honeycomb body which has passages that are closed on alternate sides. For this purpose, the honeycomb body is constructed with at least one closure element at the end sides, so that (preferably) all of the passages are closed either at one end side or the other. This has the effect, for example, of ensuring that the entire exhaust-gas stream has to flow through a metallic fleece at least once.

In this context, it is proposed herein that a fleece property be selected to be different over the thickness of the fleece, for example the porosity, the type of fibers, the provision of additives, etc. Under certain circumstances, it may also be advantageous for this and/or another fleece property to vary perpendicular to the fleece thickness, i.e. for example in the axial direction of the honeycomb body. The combination of a passage system which is closed on alternate sides and the differently configured fleece property has the advantage that the flow through the closure elements is diverted in defined directions through the fleece in a manner which can be accurately predicted. The fleece can now be adapted to these flow properties of the exhaust gas, so that, for example, particulates of different sizes are absorbed or accumulated in different regions of the fleece. This targeted absorption or accumulation of particulates can promote efficient conversion of these pollutants, for example by the provision of a catalyst in the vicinity. It is preferable for a honeycomb body of this type to be formed with a combination of at least one fleece and at least one corrugated metal foil.

With the objects of the invention in view, there is concomitantly provided a process for filtering an exhaust-gas stream. The process comprises providing a honeycomb body according to the invention, and feeding an exhaust-gas stream through the honeycomb body for filtering.

It is preferable for the honeycomb body described above to be used for filtering an exhaust-gas stream. A particular application area which should be mentioned is the automobile industry, in which case this honeycomb body may form part of a more complex exhaust system, in which the honeycomb body is combined with at least one catalytic converter, an adsorber, an SCR catalyst, a particulate trap, etc.

Other features which are considered as characteristic for the invention are set forth in the appended claims.

Although the invention is illustrated and described herein as embodied in a process for producing a honeycomb body with a metallic fleece, a honeycomb body produced by the process and a process for filtering an exhaust-gas stream, it is nevertheless not intended to be limited to the details shown, since various modifications and structural changes may be made therein without departing from the spirit of the invention and within the scope and range of equivalents of the claims, noting that the features listed individually in the claims can be combined with one another in any technologically appropriate way in order to thereby recite further configurations of the invention.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a set of diagrammatic views illustrating a variant embodiment of a process for producing a honeycomb body with at least one fleece having metallic fibers;

FIG. 2 is a longitudinal-sectional view of a honeycomb body which is closed on alternate sides;

FIG. 3 is a perspective view of a radial-flow honeycomb body;

FIG. 4 is a longitudinal-sectional view of an electrically heatable exhaust-gas treatment unit with a honeycomb body;

FIG. 5 is a perspective view of a fleece having metallic fibers; and

FIG. 6 is a side-elevational view illustrating a further variant embodiment of a process for producing a honeycomb body.

### DESCRIPTION OF THE PREFERRED EMBODIMENTS

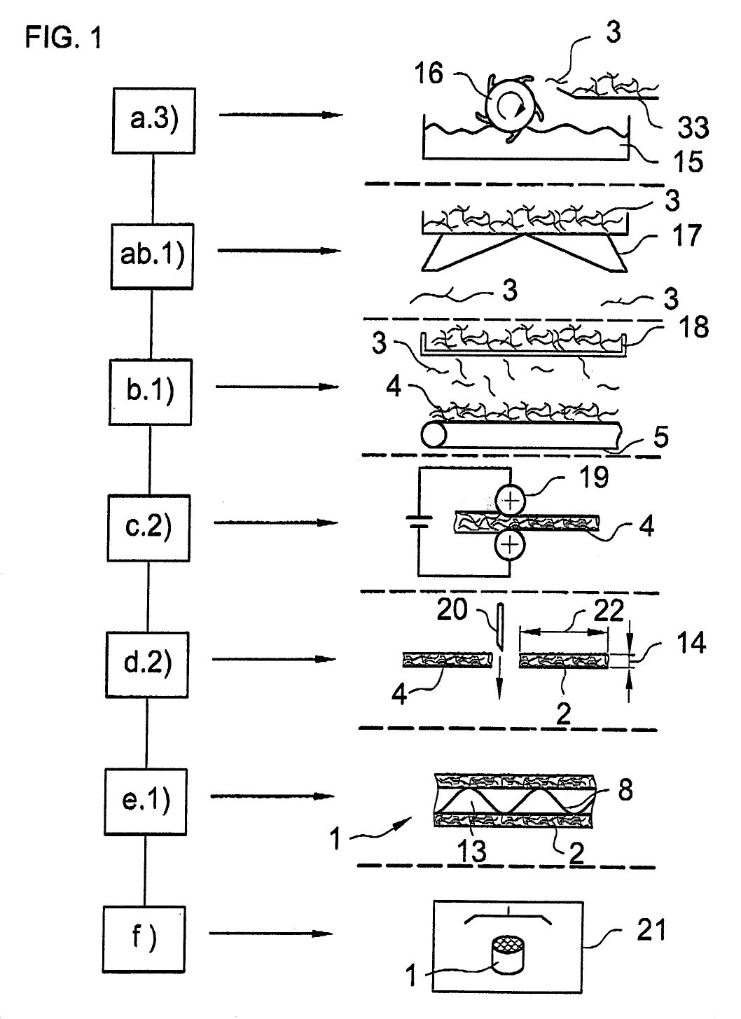

Referring now in detail to the figures of the drawings, which show particularly preferred exemplary embodiments of the invention without restricting the invention thereto and which are diagrammatic in form and in general cannot serve to illustrate size ratios, and first, particularly, to FIG. 1 thereof, there is seen a variant embodiment of a process for producing a honeycomb body. The left-hand side of the figure indicates designations of process steps used herein, while the right-hand side illustrates examples of configurations of the steps.

Accordingly, metallic fibers 3 are first of all produced by carrying out discontinuous removal from a metal melt 15, according to step a.3). In this case, a rotor 16 which rotates within the metal melt 15 generates fibers 3 which are fed to a tray 33 to set.

The fibers 3 produced in this way are then classified in accordance with step ab.1). For this purpose, the fibers 3 are fed to a sorter 17 which simultaneously also effects selection or separation of the different fibers 3, for example as a function of the shape and/or size of the fibers 3.

These fibers are then fed to a distributor 18 which layers the fibers uniformly on a base 5 to form a layer 4 (see step b.1)). In this case, the base 5 is constructed as a conveyor belt, so that the layer 4 which is generated can then be fed to a welding process.

According to step c.2), the layer 4 is passed through a welding installation 19, which is suitable for carrying out a roller seam welding operation at least once.

After this, in accordance with step d.2), the layer 4 is converted into separate fleeces 2 of a predetermined fleece thickness 14 and fleece length 22, which is done by separating the fleeces 2 through the use of a separation apparatus 20.

The fleeces 2 produced in this way are then combined with a plurality of corrugated metal foils 8 so as to form a honeycomb body 1 having a multiplicity of passages 13 (step e.1)).

The honeycomb body 1 is then also subjected to a brazing process (step f)), in order to form connections between the individual elements of the honeycomb body by a joining technique and/or to further develop the connections between the fibers made by a joining technique. The honeycomb body 1 is fed at least from time to time and preferably continuously to a furnace 21, in which a vacuum and temperatures above 1,000° C. preferably prevail. The honeycomb body 1 produced in this way is particularly suitable for use in the exhaust system of automobiles.

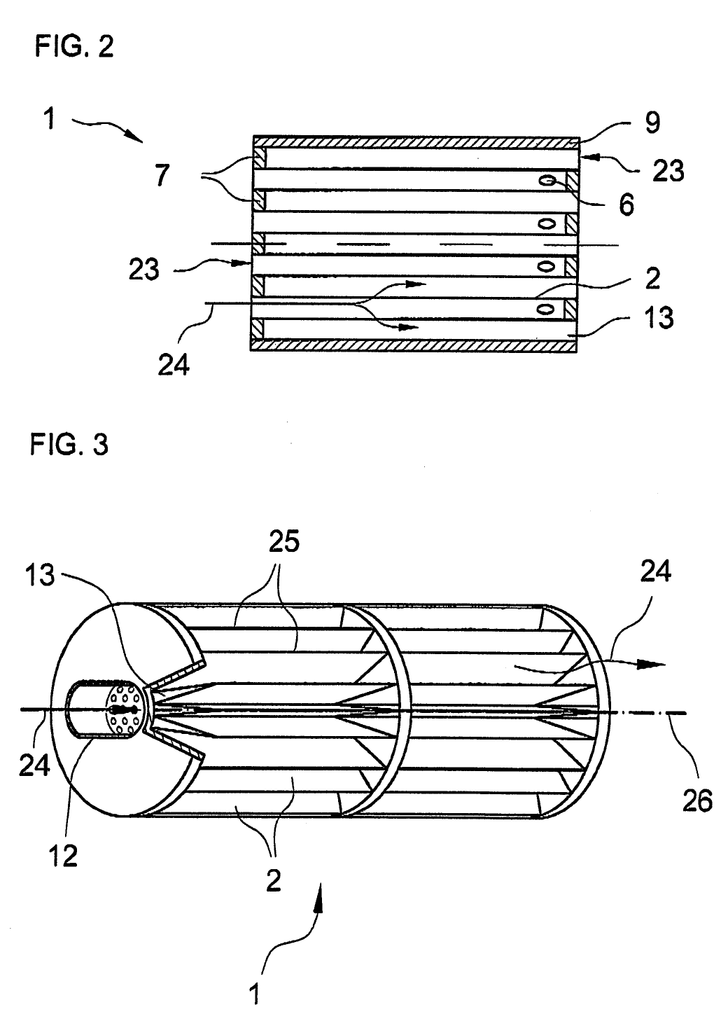

FIG. 2 shows a possible variant embodiment of a honeycomb body 1 produced by the process according to the invention. The honeycomb body 1 once again has a multiplicity of passages 13, which in this case are closed off on alternate sides through the use of closure elements 7 that are each secured to an end side 23. In this way, the exhaust gas is forced first of all to enter an open passage 13 in a flow direction 24, but then, due to the closure element 7, to flow through the fleece 2 and pass into another, adjacent passage 13. During passage through the fleece 2, particulates (such as soot and ash) in particular are retained. In order to prevent the passages 13 from becoming unusable due to soot accumulating over an excessive area, regions 6 are stamped out of the fleece 2, so as to form a type of “bypass.” The honeycomb body 1 is surrounded by a metallic housing 9.

FIG. 3 illustrates a further configuration of a honeycomb body 1 which can be produced by the process. This honeycomb body 1 has a star-shaped structure through which medium flows radially from the inside outward. For this purpose, the exhaust gas passes through a tube 12, which is provided with a perforation in the region of the honeycomb body 1. As a result, the exhaust gas passes into pockets 25 which are formed by the fleece 2 and form the passages 13. The exhaust gas emerges through these pockets 25 substantially radially with respect to an axis 26 and on the outer side is discharged again in a substantially axial flow direction 24.

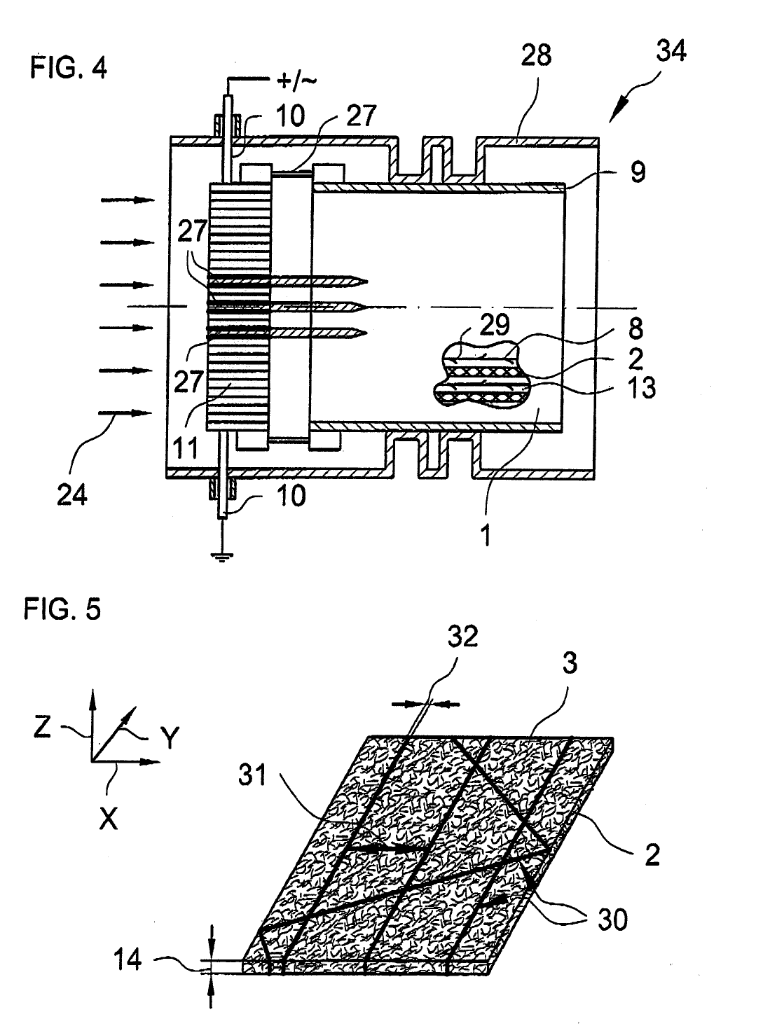

FIG. 4 illustrates an exhaust-gas treatment unit 34 which is constructed as an electrically heatable honeycomb body 1. The honeycomb body 1 itself is once again formed with a combination of metallic fleece 2 and metal foils 8, in such a way as to form (open) passages 13 which run substantially parallel to one another. Even if the passages 13 are mostly not completely closed, the metal foils 8 do have flow-influencing devices 29 which at least partially project into the passages 13 and are responsible for diverting parts of the exhaust-gas streams through the fleece 2. This honeycomb body 1 is disposed in a housing 9.

A further honeycomb structure 11, which may be configured for example as an oxidation catalytic converter, is provided at an end side of the honeycomb body 1. The honeycomb structure 11 is connected to the honeycomb body 1 through the use of (at least partially electrically insulated) pins 27. A contact-connection of the honeycomb structure 11 for a flow of electric current is effected through the use of diagrammatically illustrated electrodes 10. It is therefore possible for the exhaust gas which initially comes into contact with the honeycomb structure 11, as seen in the flow direction 24, to be heated up and in the process, for example, also allowing thermal regeneration of the downstream particulate trap including the honeycomb body 1. The entire configuration of the honeycomb body 1 with the combination of the honeycomb structure 11 is integrated in the exhaust pipe 28, for example of a motor vehicle.

FIG. 5 now illustrates in detail one configuration of the fleece 2, which includes a multiplicity of metallic fibers 3. The fibers 3 are disposed as a random layer and are connected to one another in separate connection zones 30. The connection zones 30 are constructed at a spacing 31 and with a width 32, which are substantially distinguished by the execution, for example, of roller seam welding. It should be noted in this case that under certain circumstances the width 32 may also be selected to be greater than the spacing 31. It can be seen from FIG. 5 that the fleece 2 is a substantially sheet-like structure, with the smallest dimension generally being the fleece thickness 14. The formation of the connection zones 30 can also serve to realize an anisotropic formation of at least one fiber fleece property. In addition to the connection zones 30 illustrated herein, it is possible to generate further connections by a joining technique between the fibers 3, for example sintered connections which are produced during process step f).

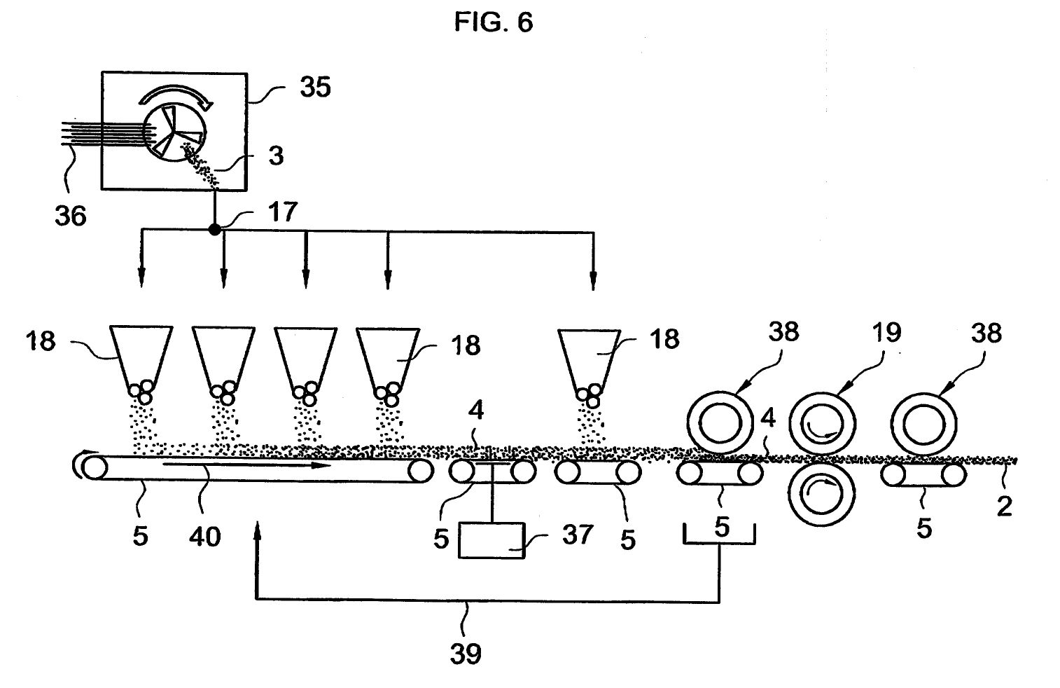

FIG. 6 diagrammatically illustrates a further variant embodiment of the process for producing a honeycomb body 1, through to production of the fleeces 2. The joining methods described above may be used to complete the honeycomb body 1. The fiber production in this case uses a cutting installation 35 which is supplied with a plurality of metallic wires 36. The cutting installation 35 has a cutting mechanism which cuts the long wires 36 into short fibers 3 in a controlled way. The fibers 2 produced in this way are classified and selected in a sorter 17 before then being fed to different distributors 18. A layer 4 is produced in two stations. Four distributors 18 are disposed above a base 5 configured as a conveyor belt within a first station, illustrated on the left. The conveyor belt then checks the layer 4 being produced for its fleece property through the use of a balance 37, and the fleece is then filled in a targeted way with the established quantity of fibers 3 that is still required, if appropriate, in a second station having a further distributor 18.

Once the desired weight per unit area of the layer 4 is present, the latter is fed to a first deformation installation 38 in a conveying direction 40. There, the layer 4 is compacted and edges of the layer 4 are precut. The fiber material which is separated off during the precutting, preferably amounting to less than 10% of the fiber material being used, is returned to the first station or at least one of the distributors 18 or the sorter 17, by a fiber feedback 39. The pretreated layer 4 then passes through a welding installation 19 which is suitable for carrying out roller seam welding at a welding rate of at least 4 m/min for a layer width in a range of over 100 mm. After the fibers 3 have been captively joined to one another, the layer finally passes through a second deformation installation 38, in which further compacting is carried out and separate fleeces 2 with predetermined dimensions are separated. These fleeces 2 can then be fed to further processing stations to form a honeycomb body 1. The method illustrated herein for producing the fleeces 2 is suitable in particular for series production, since high conveying and welding rates can be realized and at the same time a controlled addition of fibers to produce desired fleece properties is possible.

The proposed processes are suitable in particular for the series production of particulate traps for exhaust systems of automobiles.

1. A process for producing a honeycomb body with at least one fleece having metallic fibers, the process comprising the following steps:
a) producing metallic fibers;
b) forming a layer including the metallic fibers;
c) welding the metallic fibers to one another;
d) deforming the layer to form a fleece having defined fleece properties;
e) producing a honeycomb body including the fleece; and
f) brazing the honeycomb body.

2. The process according to claim 1, which further comprises carrying out step a) with at least one production method selected from the group consisting of:
a.1) separating the metallic fibers from a metal block;
a.2) continuously producing the metallic fibers from a metal melt; and
a.3) discontinuously removing the metallic fibers from a metal melt.

3. The process according to claim 1, which further comprises, during step a), taking measures, at least from time to time, to avoid an oxide layer on the fibers.

4. The process according to claim 1, which further comprises, between step a) and step b), carrying out at least one fiber preparation step ab) selected from the group consisting of:
ab.1) classifying the fibers;
ab.2) selecting the fibers;
ab.3) returning the fibers for reuse;
ab.4) cutting the fibers;
ab.5) mixing the fibers; and
ab.6) cleaning the fibers.

5. The process according to claim 1, which further comprises carrying out step b) by performing at least one operation selected from the group consisting of:
b.1) distributing the fibers on a base;
b.2) adding at least one additive to the fibers;
b.3) determining at least one layer parameter;
b.4) altering the at least one layer parameter; and
b.5) continuously moving the layer.

6. The process according to claim 1, which further comprises carrying out step c) by performing at least one operation selected from the group consisting of:
c.1) carrying out resistance welding at least once;
c.2) carrying out roller seam welding at least once;
c.3) welding under shielding gas;
c.4) compacting the layer; and
c.5) inspecting joins produced during the welding.

7. The process according to claim 1, which further comprises carrying out step d) by performing at least one operation selected from the group consisting of:
d.1) compacting the layer;
d.2) separating a plurality of fleeces from the layer;
d.3) classifying the fleeces;
d.4) winding, twisting or folding a fleece;
d.5) structuring a fleece;
d.6) stamping out regions of a fleece;
d.7) combining a fleece with at least one closure element; and
d.8) seaming the layer.

8. The process according to claim 1, which further comprises carrying out step e) by performing at least one operation selected from the group consisting of:
e.1) combining at least one fleece with at least one element selected from the group consisting of: at least one metal foil, at least one housing, at least one electrode, at least one honeycomb structure, and at least one perforated tube;
e.2) applying glue to at least one fleece or to an element connected to the at least one fleece; and
e.3) applying brazing material to at least one fleece or to an element connected to the at least one fleece.

9. A honeycomb body, comprising:
at least one fleece produced by the process according to claim 1, said at least one fleece having at least one fleece property being different over a thickness of said at least one fleece; and
passages defined at least by said at least one fleece, said passages being closed on alternate sides.

10. A process for filtering an exhaust-gas stream, which comprises the following steps:
providing a honeycomb body according to claim 9; and
feeding an exhaust-gas stream through the honeycomb body for filtering.
